(19) United States
(12) Patent Application Publication
(10) Pub. No.: US 2013/0044069 A1
(43) Pub. Date: Feb. 21, 2013

(54) PORTABLE TERMINAL AND CHARACTER INPUT METHOD FOR SAME

(71) Applicant: Wonhee Lee, Yongin-si (KR)

(72) Inventor: Wonhee Lee, Yongin-si (KR)

(73) Assignees: SISODREAM INC., Seongnam-si, Gyeonggi-do (KR); Wonhee LEE, Yongin-si, Gyeonggi-do (KR)

(21) Appl. No.: 13/643,307

(22) PCT Filed: Apr. 5, 2011
(86) PCT No.: PCT/KR2011/002367

§ 371 Date: Oct. 25, 2012

(30) Foreign Application Priority Data
May 12, 2010 (KR) 10-2010-0044580

(51) Int. Cl. G06F 3/041

(52) U.S. Cl. 345/173

(57) ABSTRACT

Disclosed are a portable terminal and a character input method thereof. Touch information corresponding to input selected by a user from a touch device is received, and a control unit calculates a region in which the touch information starts, a region in which the touch information ends, and a region in which the touch information turns. Then, the control unit determines a character corresponding to the region in which the touch information starts, the region in which the touch information ends, and the region in which the touch information turns with reference to the memory. Further, the control unit determines whether there is a motion of turning an apex of the region in a predetermined direction, and when the motion of turning the apex of the region in the predetermined direction is input, the control unit changes a character input mode. Thus, a character may be accurately and simply input by inputting a character in a predetermined region displayed on a screen larger than an existing screen by using a touch device.

### BACKGROUND OF THE INVENTION

(a) Field of the Invention

The present invention relates to a portable terminal, and particularly to, a portable terminal and a character input method thereof.

(b) Description of the Related Art

In general, simple portable electronic devices, such as a mobile phone, a smart phone, and a table PC, have been widely supplied. A touch screen, a touch pad, or the like is primarily applied to devices as an input device.

In such a mobile device, when a character is input by using a touch screen or a touch pad, a plurality of keys is primarily disposed in a small region and a character is input through the plurality of keys. However, since each character input key disposed on a display is excessively small, a user cannot accurately touch a character to input, and may incorrectly input the character due to pressing an adjacent character together. Meanwhile, a touch pen has been supplied due to the incorrect input of a character, but there is a drawback in that it is inconvenient for the senior or young people to carry and use the touch pen.

Further, in a touch input method in the related art, there are many keys through which characters are input, so that it is difficult to find a key corresponding to a character to input. In addition, in the related art, in order to solve such inconvenience, that is, the finding of a key to input and a difficult touch of an excessively small key, there is a method of inputting a character in cursive script.

However, a character recognition method is a method of writing an actual shape of a character on a touch screen, and has a drawback in that recognition of a character in a device receiving input of the character is considerably deteriorated because a user writes even the same character in different shapes, sizes, and order.

The above information disclosed in this Background section is only for enhancement of understanding of the background of the invention and therefore it may contain information that does not form the prior art that is already known in this country to a person of ordinary skill in the art.

### SUMMARY OF THE INVENTION

The technical object to be achieved by the present invention is to solve the problem in the related art, and provides a portable terminal capable of allowing a user to easily input a desired character and improving recognition of a character in a device in which a character is input by inputting a simplified character, and a character input method for the same. A portable terminal according to a characteristic of the present invention for solving the object includes:

a display unit configured to display information;

a touch input device formed on the display unit;

a memory configured to store character information representing a character corresponding to a touch shape in a predetermined region of the display unit; and

a control unit configured to receive input of the touch input device and process the received input, and display a character corresponding to touch information on the display unit by comparing the touch information output from the touch input device in a character input mode and the character information.

The control unit compares a region in which a touch starts, a region in which a touch ends, and a region in which a touch turns with the character information to determine a character to be displayed on the display unit.

The character information corresponds to an original shape of a character.

When one region is touched once in the touch information, the control unit determines a character as one of four characters of high frequency of use among the characters, and corresponding touch regions corresponding to the four characters are stored in the character information.

The character input mode includes an alphabet mode, a Korean mode, and a number mode, and the mode change method determines the mode by a motion of turning one of apexes representing the region in a predetermined direction.

A method of inputting a character of a portable terminal according to a characteristic of the present invention for solving the object includes:

receiving touch information corresponding to input selected by a user from a touch device;

calculating a region in which the touch information starts, a region in which the touch information ends, and a region in which the touch information turns by a control unit;

determining a character corresponding to the region in which the touch information starts, the region in which the touch information ends, and the region in which the touch information turns with reference to the memory by the control unit;

determining whether there is a motion of turning an apex of the region in a predetermined direction by the control unit; and

when the motion of turning the apex of the region in the predetermined direction is input, changing a character input mode by the control unit.

The character input mode includes at least two of a Korean input mode, an alphabet input mode, and a number input mode.

Input modes of various languages, such as Japanese, French, and German, may be additionally added to the character input mode according to necessity.

According to the exemplary embodiments of the present invention, a character may be accurately and simply input by inputting a character in a predetermined region displayed on a screen larger than an existing screen by using a touch device.

### BRIEF DESCRIPTION OF THE DRAWINGS

FIG. 1 is a configuration diagram of a portable terminal according to an exemplary embodiment of the present invention.

FIG. 2 is a diagram illustrating four regions for inputting a character.

FIG. 3 is a diagram illustrating a touch input method for inputting the alphabet.

FIG. 4 is a diagram illustrating the alphabet characters corresponding to touch information in a form of a table.

FIG. 5 is a diagram illustrating a touch input method for inputting numbers.

FIG. 6 is a diagram illustrating numbers and symbol characters corresponding to touch information in a form of a table.

FIG. 7 is a diagram illustrating a touch input method for inputting Korean.

FIG. 8 is a diagram illustrating Korean characters corresponding to touch information in a form of a table.

FIG. 9 is a diagram illustrating a character input method of a portable terminal according to an exemplary embodiment of the present invention.

FIG. 10 is a diagram of an initial screen of a character input mode and illustrates an alphabet input mode.

FIG. 11 is a diagram illustrating a method of changing a character input mode.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

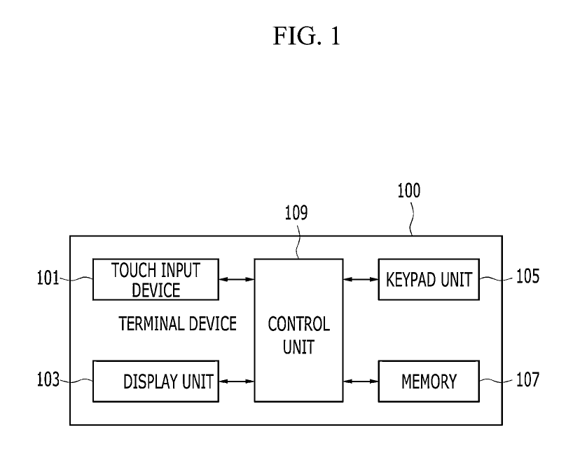

FIG. 1 is a configuration diagram of a portable terminal according to an exemplary embodiment of the present invention.

Referring to FIG. 1, a portable terminal according to an exemplary embodiment of the present invention includes a display unit 103, a touch input device 101, a keypad unit 105, and a memory 107. Further, the terminal includes an electronic device capable of performing wired/wireless communication and executing multimedia contents. For example, the terminal may include a table PC, a mobile phone, a smart phone, an ultra mobile PC (UMPC), a personal digital assistance (PDA), and the like.

The touch input device 101 is mounted on a screen of the display unit 103 on which data of the terminal is displayed in a form of a panel in order to detect a touch motion of a user. The touch input device 101 is provided in a form of a combination with the display unit 103 for output.

The display unit 103 displays a screen including data output by a control unit 109, and an image, an icon, and a menu item selectable by a user, and the like. Further, various screens according to functions implemented by the control unit 109 may be displayed, and for example, a Korean input screen, an alphabet input screen, a number input screen, an MP3 reproduction screen, a mail service screen, and the like are output.

Further, the touch input device 101 is mounted to the display unit 103 to sense a contact signal according to a touch motion of a user and transfer the detected contact signal to the control unit 109. The touch input device 101 may sense touch input according to a touch position, touch strength, and a touch direction of a user, and the like, on the display unit 103, and may be implemented in various types, such as a current sensing type or a pressure sensing type. In addition, according to an applied type, a motion state may be sensed only by proximity of a user, not a direct contact of a user.

The keypad unit 105 may receive a selection of a user and transfer the received selection to the control unit 109, and receive a selection of various functions, such as power on/off, according to necessity. When the terminal is a full touch phone, the keypad unit 105 may perform only a power on/off function.

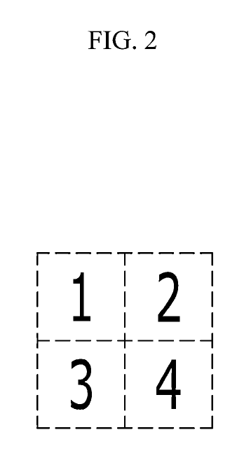

Character information corresponding to touch information that is a sensing signal for a touch motion is stored in the memory 107, which will be described in detail with reference to FIGS. 2 to 8.

FIG. 2 is an example of a screen on which four regions for receiving character input are displayed, and the regions are denoted by numbers, that is, region number 1 to region number 4, as illustrated in FIG. 2. For example, among the four regions, a left-upper end is referred to as number 1, a right-upper end is referred to as number 2, a left-lower end is referred to as number 3, and a right-lower end is referred to as number 4.

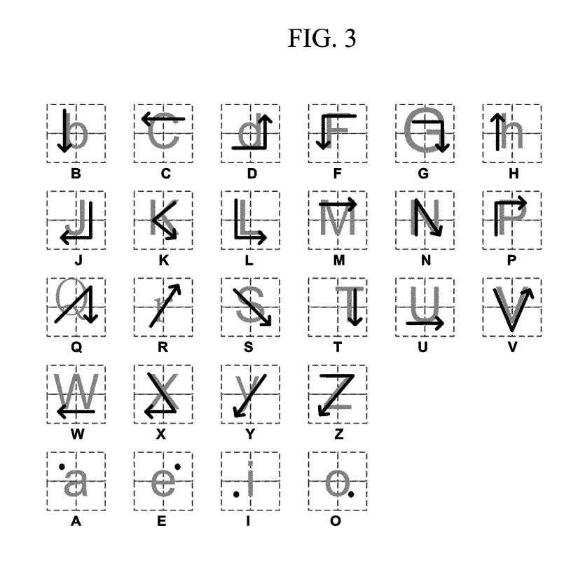

FIG. 3 is a schematic diagram illustrating a character input method in an alphabet mode (English mode).

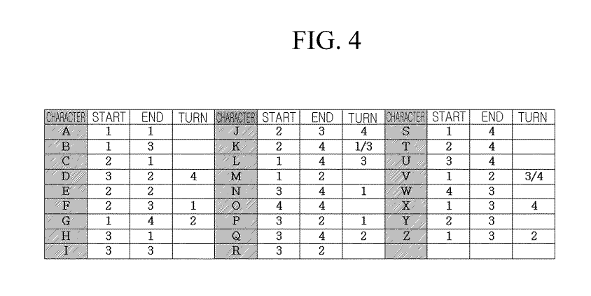

Referring to FIG. 3, in an exemplary embodiment of the present invention, a shape of an alphabet is simplified and input in the four divided regions of the screen of the display unit 103. When a touch is made in this manner, the control unit 109 recognizes a corresponding alphabet from touch information output from the touch input device 101 with reference to the table of FIG. 4 of the memory 107 and displays the recognized alphabet on the display unit 103.

One region touched among the four regions is allocated for the touch of four vowels (a, e, i, and o) among the five vowels (a, e, i, o, and u) of the English alphabet of high frequency of use, and such an allocation method may be changed according to necessity. 22 characters including one vowel (u) that is not allocated among the five vowels and 21 consonants of the English alphabet are regulated as touches of the four regions in a form illustrated in FIG. 3. Such a recognition method may be modified according to necessity, and is not limited to FIG. 3. By the aforementioned method, all alphabets may be input.

Further, a dot in each region of the vowels, a, e, i, and o, in FIG. 3 is marked in order to indicate that it is sufficient to simply touch each region once.

In the simplification of the characters as illustrated in FIG. 3, the characters are discriminated by a direction of a touch, as well as a shape of a touch. For example, M is written from left to right, and C is written from right and left. Arrows of FIG. 3 represent the directions.

As described, the input of the character is discriminated and recognized by a position identification described below. That is, the touch information is a start position among the four regions, an end position among the four regions, and a turn position among the four regions.

Here, the touch information may be a line shape without disconnection, a trace shape, a straight line shape, or a dot shape. From a moment at which a touch for one character starts to a moment at which a hand is taken off the touch input device for one character may be recognized as one piece of the touch information.

For example, for an alphabet L, the touch information starts in region number 1, turns in region number 3, and ends in region number 4.

Then, for an alphabet M, the touch information starts in region number 1 and ends in region number 2, and there is no region in which the touch information turns.

For an alphabet A, the touch information starts in region number 1, and there is no region in which the touch information ends and turns.

For an alphabet V, the touch information starts in region number 1, turns in region number 3 or 4, and ends in region number 2.

Here, since a vowel generally has a lot of numbers of input times, a vowel may be input by a touch of each region only once in order to increase an input speed.

A table for determining the input is illustrated in FIG. 4. That is, a user performs a touch according to the method of FIG. 3, and the control unit 109 recognizes the alphabets with reference to the table of FIG. 4. Further, the character is simplified in a shape similar to the character so that a user easily memories the input method.

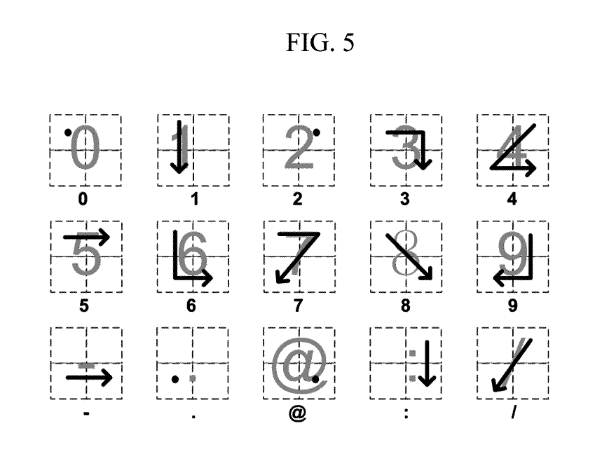

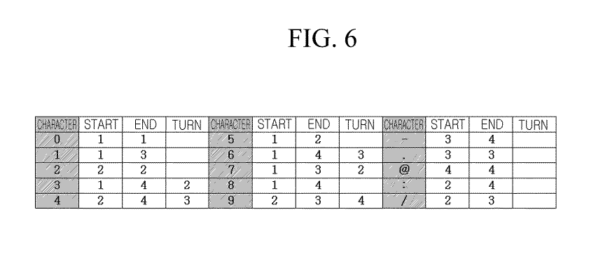

Further, in a similar method, numbers and symbols are simplified as illustrated in FIG. 5 and input in the touch input device 101 in a number input mode. In addition, the control unit 109 determines a number and a symbol corresponding to the touch information by using a table stored in the memory 107 like FIG. 6.

Referring to FIG. 5, respective four regions are allocated for the touch of four numbers or symbols, and may be modified according to necessity.

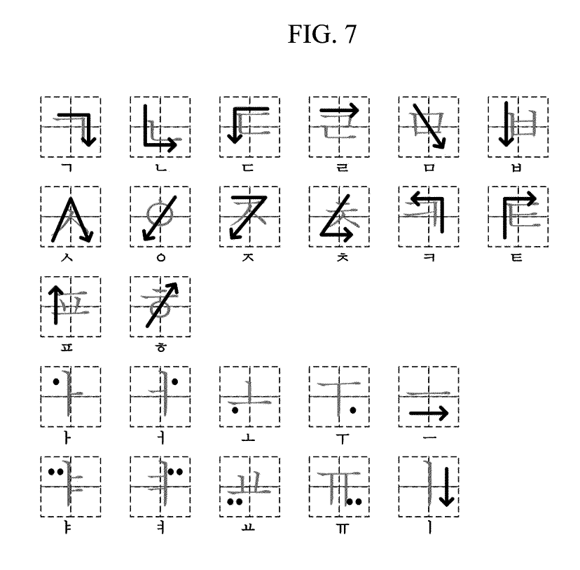

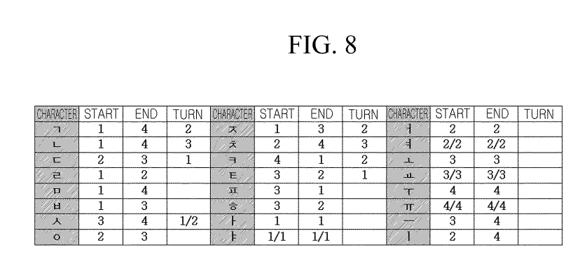

Further, in a similar method, Korean may be simplified as illustrated in FIG. 7 and input to the touch input device 101 in a Korean input mode. In addition, the control unit 109 determines Korean corresponding to the touch information by using a table stored in the memory 107 like FIG. 8.

Referring to FIG. 7, similarly to the English alphabet, the vowels of the Korean are input by touching respective regions (here, — and ┐ are excluded). Two dots represent two touches. Since there is no case in which a vowel is continuously written twice in Korean, another character may be displayed by touching the region twice.

The control unit 109 are connected with the touch input device 101, the display unit 103, the keypad unit 105, and the memory 107 to control an organic operation between the respective constituent elements.

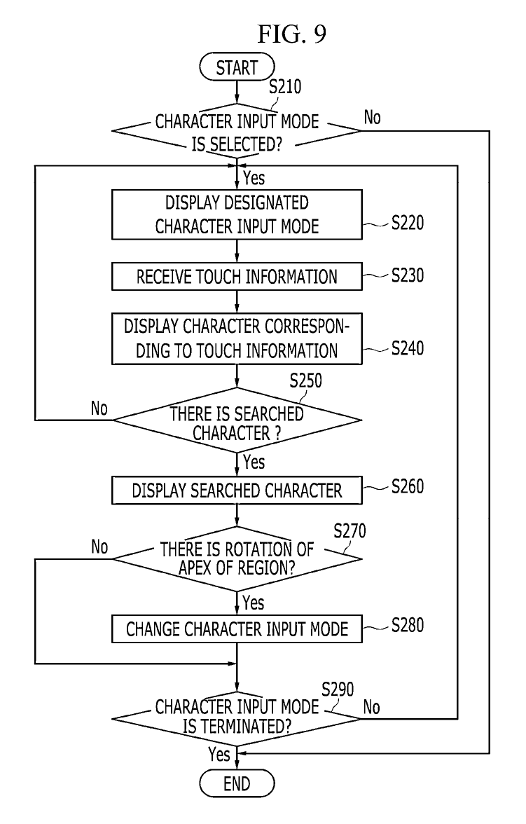

Particularly, the control unit 109 executes a pre-defined function according to the touch information sensed from the touch input device 101, and a detailed operation thereof will be described in detail with reference to FIGS. 9 to 11.

FIG. 9 is an operation flowchart illustrating a character input method of a portable terminal according to an exemplary embodiment of the present invention

Referring to FIG. 9, a user first operates a terminal and selects a character input mode (S210).

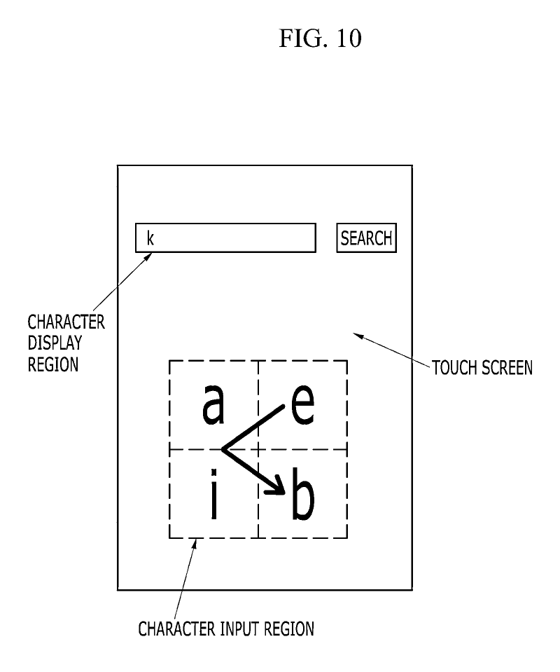

Then, the control unit 109 displays an initial character input screen like FIG. 10 on the display unit 103 (S220). In this case, an initial mode is set to an alphabet mode. The initial character input mode may be changed to a Korean mode or a number mode according to necessity.

Meanwhile, the character input mode includes a Korean input mode, an alphabet input mode, and a number input mode, and input modes of various languages, such as Japanese, French, and German, may be added to the character input mode according to necessity.

First, it is assumed that a user desires to input an alphabet.

When the user performs a touch by a method corresponding to a desired character, the control unit 109 receives touch information corresponding to input selected by the user from the touch input device 101 (S230).

Next, the control unit 109 calculates a region in which the touch information starts, a region in which the touch information ends, and a region in which the touch information turns. According to necessity, the control unit 109 may define the input within a predetermined time from a time at which a first touch is generated as one piece of touch information by using an internal timer (not illustrated in the drawing). Further, the control unit 109 may also define a duration for which the touch is continuously connected as one piece of touch information.

Next, the control unit 109 searches for a character corresponding to the region in which the touch information starts, the region in which the touch information ends, and the region in which the touch information turns with reference to the table of the memory 107 illustrated in FIG. 4 (S240).

Then, the control unit 109 determines whether there is a searched character (S250).

When there is the searched character, the control unit 109 displays the searched character on the display unit 103.

Meanwhile, when there is no corresponding character, the control unit 109 displays nothing on the display unit 103 and performs the character input standby step (S220) again.

Next, the control unit 109 determines whether there is a motion of turning an apex of the region in a predetermined direction (S270).

When the motion of turning the apex of the region in the predetermined direction is input, the control unit 109 changes the character input mode (S280).

In this case, the character input mode is changed in a sequence of the alphabet mode, the number mode, and the Korean mode, and such a sequence may be varied according to necessity.

The method of changing the character input mode will be described in more detail below.

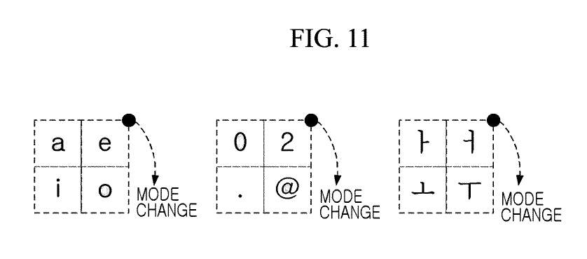

FIG. 11 is a diagram illustrating a method of changing the character input mode.

Referring to FIG. 11, when the user touches a motion of touching and turning one of respective apexes of the four regions displayed on the display unit 103, the control unit 109 recognizes the touch and changes the character input mode.

When the mode is changed, the control unit 109 may display a character which is to be input when each region is touched once in advance in order to display the changed mode.

Further, the change of the character mode may be performed by another part, not the apex, and may be changed according to necessity, and the steps S270 and S280 of determining the mode change may be performed before the steps S230 and S240 of receiving the touch information and displaying the character according to necessity.

Next, when there is a selection for terminating the character input mode, the control unit 109 terminates the character input mode, and when there is no selection for terminating the character input mode, the control unit 109 repeats the process from the step S220.

In the exemplary embodiment, the memory is described as an essential constituent element, but the control unit may also implement the character input function by adding character information to the program as a reference value during the execution of the program and comparing the character information with the touch information without the memory according to necessity.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A terminal comprising:
a display unit configured to display information;
a touch input device formed on the display unit;
a memory configured to store character information representing a character corresponding to a touch shape in a predetermined region of the display unit; and
a control unit configured to receive input of the touch input device and process the received input, and display a character corresponding to touch information on the display unit by comparing the touch information output from the touch input device in a character input mode and the character information.

2. The terminal of claim 1, wherein:
the control unit compares a region in which a touch in the touch information starts, a region in which a touch in the touch information ends, and a region in which a touch in the touch information turns with the character information to determine a character to be displayed on the display unit.

3. The terminal of claim 1, wherein:
the touch shape of each character of the character information corresponds to an original shape of a character.

4. The terminal of claim 1, wherein:
characters of high frequency of use are allocated to the divided regions one by one in order, and the control unit determines a character allocated to a corresponding region when the touch shape of the touch information is a touch of one region once.

5. The terminal of claim 1, wherein:
the character input mode includes an alphabet mode, a Korean mode, and a number mode.

6. The terminal of claim 1, wherein:
the mode change method determines the mode by a motion of turning one of apexes representing the region in a predetermined direction.

7. A terminal, comprising:
a display unit configured to display information;
a touch input device formed on the display unit; and
a control unit configured to receive input of the touch input device and process the received input, display the predetermined number of regions on the display unit in a character input mode, and compare touch information output from the touch input device with character information serving as a reference when a user touches the region to display a character corresponding to the touch information on the display unit,
wherein a touch shape of each character of the character information corresponds to an original shape of a character.

8. A method of inputting a character of a terminal, comprising:
receiving touch information corresponding to input selected by a user from a touch device;
calculating a region in which the touch information starts, a region in which the touch information ends, and a region in which the touch information turns by a control unit; and
determining a character corresponding to the region in which the touch information starts, the region in which the touch information ends, and the region in which the touch information turns with reference to the memory by the control unit.

9. The method of claim 8, further comprising:
determining whether there is a motion of turning an apex of the region in a predetermined direction by the control unit; and
when the motion of turning the apex of the region in the predetermined direction is input, changing a character input mode by the control unit.

10. The method of claim 9, wherein:
the character input mode includes at least two of a Korean input mode, an alphabet input mode, and a number input mode.

11. The method of claim 10, wherein:
the character input mode further includes at least one character input mode of a Japanese input mode, a French input mode, and a German input mode.

12. The terminal of claim 2, wherein:
the character input mode includes an alphabet mode, a Korean mode, and a number mode.

13. The terminal of claim 3, wherein:
the character input mode includes an alphabet mode, a Korean mode, and a number mode.

14. The terminal of claim 4, wherein:
the character input mode includes an alphabet mode, a Korean mode, and a number mode.

15. The terminal of claim 2, wherein:
the mode change method determines the mode by a motion of turning one of apexes representing the region in a predetermined direction.

16. The terminal of claim 3, wherein:
the mode change method determines the mode by a motion of turning one of apexes representing the region in a predetermined direction.

17. The terminal of claim 4, wherein:
the mode change method determines the mode by a motion of turning one of apexes representing the region in a predetermined direction.
